(19) United States
(12) Patent Application Publication
(10) Pub. No.: US 2026/0154153 A1
(43) Pub. Date: Jun. 4, 2026

(54) Memory Management Using Flexible Representations for Page Prediction

(71) Applicant: MEXT Corporation, Santa Clara, CA (US)

(72) Inventors: Carl WALDSPURGER, Palo Alto, CA (US); David P. REED, Needham, MA (US)

(73) Assignee: MEXT Corporation, Santa Clara, CA (US)

(21) Appl. No.: 19/399,602

(22) Filed: Nov. 24, 2025

Related U.S. Application Data
(60) Provisional application No. 63/727,589, filed on Dec. 3, 2024.

(51) Int. Cl. G06F 11/10; G06F 12/0882

(52) U.S. Cl. CPC G06F 11/1064; G06F 11/1048; G06F 12/0882

(57) ABSTRACT

Types of deltas other than those associated with absolute distance within a virtual address space are used in a memory management system to flexibly represent distances in different spaces and provide access predictions that inform prefetching from swap memory to near memory. Some deltas may represent spatial distance in the space of swapped-out pages and other deltas may represent temporal distance such as differences in swap-out times. In some of these spaces, even small deltas can represent large distances in the virtual address space. Deltas of different granularities may be used. The access predictions may also be used to filter and suppress potential swap-outs as well.

### REFERENCE TO RELATED APPLICATIONS

This application claims priority of U.S. Provisional Patent Application No. 63/727,589, filed 3 Dec. 2024.

### TECHNICAL FIELD

This application relates to memory management in computing systems.

### BACKGROUND ART

A computing system generally uses many different memory technologies. The fastest memory other than CPU registers themselves is usually static random access memory (SRAM), which is used to implement different caches and is thus both physically and logically closest to the CPU core. Slower memory such as dynamic random access memory DRAM is then often used for the system's main storage technology. These relatively fast SRAM and DRAM memory technologies are thus used for primary system memory. An even slower technology such as “flash memory” found in a solid-state drive (SSD) is often used for secondary storage, although RAM-based mass-storage devices are available as well. Memory devices such as SSDs are typically on the order of thousands of times slower than DRAM.

Since processing speed depends heavily on the speed in both read and write access to memory, both primary and secondary, memory speed is always important, but for many applications it is essential. As just one of countless examples, a single 4 MB image may require 1024 4 KB pages of memory, where a “page” is a contiguous block of virtual memory, described by a single entry in a page table. Many application servers, for example, spend more than 50%—and often significantly more—of the time stalled on memory, especially when they use a memory storage appliance with which they communicate via a network.

One might think that the easiest way to increase read and write speed would simply be to use the fast SRAM memory technology everywhere. This would, however, ignore the much higher and usually prohibitive cost of doing so.

Predicting future memory accesses or page faults makes it possible to fetch data that is likely to be needed in advance. One method that attempts to reduce latency is known as “prefetching”. Implemented using either software, or hardware, or both, prefetching involves the loading of a resource, such as pages or other blocks of memory, before it is required. The goal of prefetching is thus to reduce memory latency.

Such prefetching hides the latency of accessing data stored in a slower far memory, such as pages that have been swapped out to local flash storage or remote DRAM, by moving them into near memory, such as local DRAM. Existing techniques for predicting future accesses include both heuristic approaches and the use of machine learning (ML)-based models.

Physical vs. Virtual Address Spaces

As is well known, physical addresses refer to actual hardware memory locations, whereas “virtual” addresses are memory addresses that are generated by the CPU during a program's execution. Virtual addresses are used within the context of a process or task and are translated by a memory management unit (MMU), including translating a virtual address into a physical address before an actual memory access is performed. The use of virtual addresses allows a program to behave as if it has exclusive use of the main memory, even though other processes are also running and using the same memory. It also enables memory overcommitment, where the total amount of virtual memory exceeds the total amount of physical memory, using techniques such as swapping.

### Heuristic Prefetchers

Current operating systems commonly employ simple heuristics that prefetch the next few pages following a fault. For example, Linux can be configured to prefetch pages following a page fault that are either sequential in the virtual address space of the faulting process, or sequential in the physical swap storage space (see Ying Huang, “mm, swap: VMA based swap readahead”, LWN Article, 2017—“Huang”). More sophisticated heuristic prefetchers can detect stride-based patterns among the virtual addresses of pages referenced in memory access streams. Examples of these heuristic prefetchers are described in Li et al., “HoPP: Hardware-Software Co-Designed Page Prefetching for Disaggregated Memory”, in HPCA 2023 (“Li”) and Al Maruf et al., “Effectively Prefetching Remote Memory with Leap”, in ATC 2020 (“Al Maruf”).

More generally, heuristic swap prefetchers are focused on finding patterns of deltas representing relative distances between pages. Most approaches, including swap vma readahead in Linux (Huang), compute deltas in the virtual address space, exploiting the spatial locality exhibited by applications. Deltas in the physical swap storage space have also been used, including swap cluster readahead in Linux, in order to exploit spatial locality in the physical swap space.

The effectiveness of existing heuristics may also depend on the swap storage medium. When swap cluster readahead was developed, swap devices were commonly hard disk drives (HDDs), for which sequential readahead is relatively inexpensive, since it does not require slow mechanical disk seeks. However, most modern systems instead swap to faster media, which do not require such operations, such as solid-state disks (SSDs). In practice, swap vma readahead is generally considered more effective than swap cluster readahead for modern swap devices.

Yet another limitation of existing heuristics is that they are typically inflexible, and often rely on hardcoded parameters or settings, making them difficult to adapt to dynamic workloads.

### ML-Based Prefetchers

ML-based prefetchers learn patterns of deltas representing relative distances in the virtual address space. Similar to heuristic approaches, they exploit spatial locality in the virtual address space, as exhibited by most applications. The use of small deltas for ML models is also motivated by practical constraints on model sizes. The number of unique memory addresses accessed by an application is commonly several orders of magnitude larger than the number of unique words in natural languages. As a result, ML-based techniques designed to model and predict memory access patterns can suffer from a “class explosion” issue: If each unique address is a potential class to be predicted by the ML model, the final layer of the neural network would need a corresponding number of output neurons, leading to a massive, unwieldy model. Such a large model would consume too much memory and require significant computation time for inference and training, making it impractical for use in a prefetcher which has strict latency and storage overhead requirements.

To address this issue, prior research on ML-based cache-line prefetching has focused on predicting relative address deltas instead of absolute addresses, since the number of unique deltas is dramatically smaller than the set of absolute addresses. Examples of these methods are described Hashemi et al., “Learning Memory Access Patterns”, in ICML 2018 (“Hashemi”), Shi et al., “A Hierarchical Neural Model of Data Prefetching”, in ASPLOS 2021 (“Shi”) and Zhang et al., “Fine-Grained Address Segmentation for Attention-Based Variable-Degree Prefetching”, in CF 2022 (“Zhang”).

Similarly, a system is disclosed in U.S. patent application Ser. No. 18/751,088 (“Intelligent, Predictive Memory Management System and Method”), that uses an ML model to predict deltas between a current faulting page and other nearby pages that are likely to be accessed in the near future. In that system, a page delta represents an absolute spatial distance in the application's virtual address space, which reduces the number of classes in the model. To further reduce the number of predicted classes, deltas are typically constrained to be within some limited distance from the current faulting page, such as ±64 pages (equivalent to ±256 KB with 4 KB pages).

Existing prefetching techniques based on deltas between virtual addresses are often effective for applications with strong spatial locality. However, a narrow focus on virtual address deltas is inflexible and suboptimal, as it ignores other important locality patterns, including temporal locality, that can improve prediction accuracy. Moreover, the use of a small, limited range for deltas constrains the set of predicted pages, which makes it impossible to capture memory access patterns that span larger distances in the virtual address space.

What is needed is a method that can make better predictions by leveraging more general notions of locality, ideally with the ability to predict pages that span larger distances in the virtual address space.

### DETAILED DESCRIPTION

At the highest level, the invention provides a memory management arrangement in which additional types of “deltas” are introduced to flexibly represent distances in different spaces. This then makes it possible to improve predictions by considering deltas other than those associated with absolute distance within a virtual address space. Once this novel memory management arrangement generates its prediction of memory access patterns using any of the embodiments described below, this information may be transferred to any known prefetching mechanism to act on the prediction and swap in the appropriate pages. One embodiment further provides for filtering potential swap-outs as well, which can then be used to inform the appropriate system-level mechanism that performs such swap-out operations.

Some of the novel deltas that different embodiments of the invention consider to improve page prediction include those that represent spatial distance in a different space (such as the set of swapped-out pages) than is considered in conventional systems, as well as deltas that represent temporal distance (such as differences in swap-out times). In some of these spaces, small deltas can even represent large distances in the virtual address space.

Multiple, different types of deltas can be used together in a single memory management arrangement to further improve prediction accuracy. The deltas used in embodiments of this invention may, moreover, include coarse-grained deltas that cover more than a single page, as well as deltas with variable granularities that are finer for smaller deltas, and coarser for larger deltas.

TABLE 1

| locality type | space | ordered by | prior art |
|---|---|---|---|
| I. spatial | all pages | virtual address | Linux and many |
| | | | systems (Huang, Al |
| | | | Maruf, Li, Hashemi, |
| | | | Shi, Zhang) |
| II. spatial | swapped-out pages | physical swap | Linux (Huang) |
| | | offset | |
| III. spatial | swapped-out pages | virtual address | N/A (novel) |
| IV. temporal | swapped-out pages | swap-out count | N/A (novel) |
| V. temporal | swapped-out pages | swap-out time | N/A (novel) |

In embodiments of this invention, predicted page accesses are computed relative to the current page fault, which essentially classifies predictions using a compact description, specified as a delta in some space. Below, several novel generalizations of deltas in the space of swapped-out pages, with various orderings, are discussed. Table 1 above gives a comparative overview of the types of spaces and their ordering as used in some well-known prior art systems, as well as in embodiments of this invention (indicated as “N/A (novel)” in the “prior art” column). Table 1 does not list all of the distinctions between the prior art and the invention, however; for example, prior heuristics- and ML-based models predict deltas in the virtual address space without considering which pages have actually been swapped out. As Table 1 summarizes, however, unique to this invention is that it predicts which pages should be pre-fetched based on characteristics of swapped-out pages, where the characteristics may be spatial (in the virtual address space) or temporal.

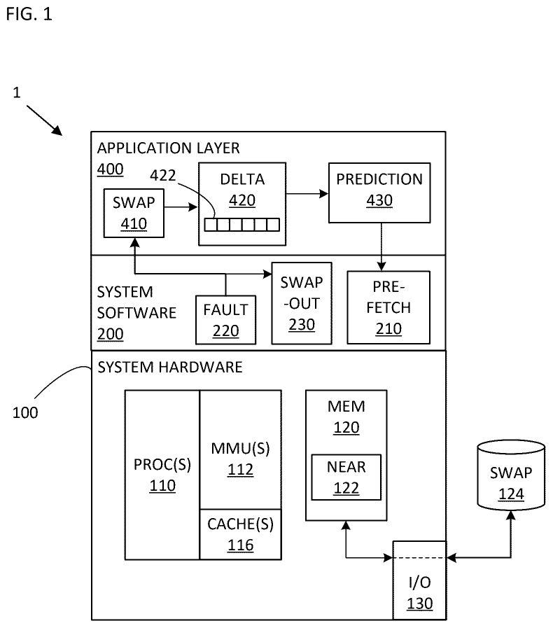

FIG. 1 illustrates the main hardware and software components of a system 1 that incorporates the invention. As in other computing platforms, the system will include system hardware 100, system software 200, and an application layer that runs in non-privileged mode. The system software 200 will include some form of operating system (OS). The system hardware 100 will include one or more central processors 110 and will include or be able to access both volatile and non-volatile storage. To enable this access, each processor 110 will be associated with a respective memory management unit 112 and at least one cache 116.

In particular, the hardware system will include or be able to access memory units 120, at least one of which is assumed here to be the memory into which pre-fetched pages are to be swapped, labeled as the “near” memory 122 in the figure. The memory 120 is also connected, using any conventional I/O device, driver, etc., as needed, to one or more “swap” memory units 124 to which pages are swapped out and from which pages are swapped in. In one prototype of the invention, the near memory 120 was DRAM and the swap memory 124 was a flash memory unit, for example an NVMe SSD device. In many cases the swap memory 124 will be slower than the near memory 122, but this is not a necessary limitation for the invention. Although the swap memory 124 is shown in the figure as being external to the system hardware 100 as such, it may also be considered to be part of system hardware and may, in some implementations, in fact be configured as an integral component of the system components, needing no I/O 130 for external communication. The swap memory 124 may, for example, simply be implemented with a slower technology, a couple examples of which are Compute Express Link (CXL) memory, and Intel Optane Persistent Memory (PMem) DIMMs.

Other standard components such as I/O units 130 may also be included to enable communication with other components, entities and systems over any known type of network, wireless or wired, including, in the illustrated embodiment, the external swap memory 124. The processor-executable code organized as software modules used to carry out the various computations, routines, and functions described below may be stored and thus embodied in the volatile or non-volatile memory or other storage components. The respective software modules, in particular a swap component 410, a delta computation component 420 and a prediction component 430 (all described below) will thus comprise processor-executable code that, when run by the processor(s) 110, cause the processor(s) to carry out the corresponding functions.

Most modern systems implement hardware cache-line prefetching but may also include software swap prefetching using a dedicated prefetch component, such as code that prefetches pages from SSD into DRAM. In the illustrated embodiment this prefetch component 210 is shown as residing in the system software, but this is only one implementation choice; it may instead be implemented in either user-space (application layer 400) or in the operating system kernel, in firmware or even in hardware.

In the illustrated embodiment, the novel components that enable the invention run in the application layer, but this is by way of example only; they may instead be incorporated into, for example, the system's operating system. One such component 410 inputs information that identifies which pages of memory have been swapped in and out between swap memory 124 and near memory 122.

In general, every attempt to access a page that is located in the swap memory 124 will cause a page fault. In many computing systems, a page fault switches control from the faulting application code to privileged OS code 220 to handle the page fault. This is intended to be transparent to the application, that is, the OS swaps in the page, updates a page-table entry to map it, and then resumes executing the application. Note that some system software may choose to expose this information to user-mode applications, as illustrated by the arrow connecting components 220 and 410. Some other systems such as Linux Userfaultfd (UFFD) even support passing page faults from the kernel to user-space code to handle them. The invention is not limited to any particular arrangement by which the information about which pages have been swapped in or out is passed to the swap component 410 in the application layer.

Note that “page fault” and “swap-in” are closely related, but not synonymous. All swap-ins are in response to “not present” page faults, but not all page faults require swap-ins to resolve. Aside from “not present”, a page fault may also occur for various other reasons, such as a “protection” fault, for example, trying to write to a read-only page, as in systems that use copy-on-write.

The invention provides and uses many alternative ways to generate actionable and useful predictions to inform prefetching decisions, not only as sets of deltas relative to the current page fault, but as sets relative to the recent history of multiple page fault events. In contrast, prior art models such as TransFetch (Zhang) do not predict when (in time or order) the predicted memory locations (in the TransFetch case, at cache-line granularity instead of page granularity) may be accessed, even though the model inputs include both ordering and timestamps. Nor do they predict that there may be two, three or more loci of accesses in the full process address space-such that the prediction set might be encodable as relative to two or more of the loci-perhaps the current page fault address and a prior page fault in the same address space.

### Spatial Deltas Relative to Swapped-Out Pages

Instead of distance in the contiguous virtual address space, some embodiments of the invention use deltas that represent distances in a spatially ordered data structure of swapped-out pages. In other words, in these embodiments, the system creates and orders the data structure 422 of swapped-out pages according to their virtual addresses, and computes deltas between pages as the difference between their positional indices in this ordered data structure. The pages that the system selects for prefetching are thus determined according to their locality in what can be termed a system-constructed “swap space”.

In FIG. 1, the data structure is labeled 422, within a delta computation module 420, which inputs the relevant information concerning swapped out pages, including their identifiers (in particular, their addresses) from the module 410 and orders its entries, which include respective page identifiers, according to the nature of deltas to be considered, in particular, according to chosen characteristics of swapped-out pages. Table 1, for example, shows three such orderings—by virtual address, by swap-out count and by swap-out time. Note that, if more than one type of delta order is considered to inform prefetching, then a corresponding data structure will be included for each type.

In order for the component 420 to create the entries to be entered into the data structure, it must have the relevant swap-out data. In systems that do not expose swap-out data to user-level applications in some other way, a swap-out component 230 included in the system software 200 is therefore preferably included to pass the required swap-out data to the swap component 410. Based on the accumulated swap-out deltas, a prediction module 430 then passes its predictions, that is, the identifiers of “candidate pages”, to the pre-fetcher 210, which may then pre-fetch them or any number of them depending on any other criteria that it is configured to consider.

One example of a data structure that the system may create for ordering of the swapped-out pages is a straightforward linear list. This is not the only possible choice, however. For example, a linked list, a skip list, or a tree-based data structure that supports traversal by key (here, virtual address) are three alternatives. Skilled programmers will be able to choose other appropriate data structures as well.

For example, suppose that the system is processing a fault to page P, and that the pages nearest to P (in terms of distance in virtual address space) that have been swapped out are . . . , M, N, O, (P), Q, R, S, . . . —where M has a “delta” Δ=−3 from P, and Q has a delta Δ=+1—regardless of their actual page-number deltas representing distance in the virtual address space.

Embodiments of the invention leverage an observation that pages that were swapped out from near to swap memory close enough to a faulting page P, that is, with small enough deltas according to a chosen ordering, are often good candidates to be pre-fetched along with P, which also was swapped out previously and is represented in the data structure. For example, in implementations in which the prefetcher is heuristic, the prediction module 430 could be set to select as candidates all the pages in the ordered data structure whose delta values are Δ≤n, or Δ≤|n|. Using the example above, if n=1, then when the system faults on page P, the prediction module may also suggest to the pre-fetcher 210 that it should also pre-fetch page Q; if n=2 and the candidate criterion is Δ≤|n|, then pages N, O, Q and R may be determined to be the candidate pages suggested to the prefetch module 210; and so on. Different ordering schemes and methods for determining delta values are described below, as well as embodiments in which n is not a single, fixed value applied to all the pages in the data structure.

Since the set of swapped-out pages will often be relatively sparse, a delta in the space of swapped-out pages can span a much larger range of the virtual address space than can a delta in the virtual address space alone, even when the delta value as such is limited to the same size/range, such as +/−64. In other words, since only some pages in the contiguous virtual address space will be swapped out, using spatial deltas that consider only swapped-out pages increases the effective “reach” of deltas in the virtual address space.

### Temporal Deltas Relative to Swapped-Out Pages

As an alternative to or in conjunction with spatial deltas relative to swapped-out pages, embodiments may instead or in addition use deltas based on when pages were swapped out, such as distance in a temporally ordered data structure (such as an array, ring buffer, list, tree, etc., as above) of swapped-out pages. This ordering captures potentially useful information about pages within an application that may even be used to inform heuristics or patterns learned by ML-based models. For example, in some cases, pages deemed cold enough to be swapped out around the same time may imply that they are likely to become hot again around the same time.

In the embodiment corresponding to type IV in Table 1, the entries in the data structure 422 of swapped-out pages may be ordered by the times when they were swapped out. The system, for example, the delta module 420, then computes deltas between pages as the difference between their indices in this ordered data structure. A different type of temporal deltas, computed as quantized absolute swap-out time differences and corresponding to type V in Table 1, is described below.

To keep track of when a page was swapped out, the system may associate per-page state to store either a timestamp (for deltas representing absolute time differences), or a swap count (for deltas representing distance in swap-out order). However, since such a state representation (e.g. 32 bits) may be made much smaller than the size of a page (e.g. 4 KB), the space overhead will be relatively small, although it will typically be memory-resident (vs. the page itself, which is on slower storage like SSD).

Although it would be possible to dynamically sort the pages in the data structure 422, this would in most cases be too expensive. One way to avoid the need for dynamic sorting is to establish and increment a “swap-out counter” or “index” as each page is swapped out and use any appropriate data structure to find pages with nearby counters. For example, assume that page P is swapped out when the counter has the value k. The next page swapped out—page Q—would then be associated with the counter value k+1, then the next page R would be associated with counter value k+2, and so on. The values of the swap-out counter associated with each swapped out page will therefore “automatically” create a temporal ordering of the pages. Ordering by swap-out count may, for example, be implemented as a free-running counter per address space that is incremented on every swap-out within that address space. For example, the pages could be threaded together in a time-ordered list. Another option would be to store swapped-out pages in an auxiliary data structure organized as a linear array, implicitly indexed by swap-out counter (modulo array size). Storing the counter associated with each page in the main mapping structure would then enable finding temporal neighbors in this array efficiently.

For example, suppose that the system is processing a fault to page P, and that the pages nearest to P (in terms of the times at which they were swapped out) that have been swapped out are . . . , M, N, O, (P), Q, R, S, . . . —where M has a delta of Δ=−3 from P, and Q has a delta of Δ=+1—regardless of their actual page-number deltas representing distance in the virtual address space.

Alternatively, instead of distance in the temporally ordered list of swapped-out pages, deltas could be defined in terms of absolute differences between the times that they were swapped out, quantized into fixed periods, such as 100 us or 10 ms. For example, the quantized absolute time delta between two arbitrary pages P₁ and P₂ may be computed as (P₂.swap_out_timestamp−P₁.swap_out_timestamp)/quantum, converted to an integer by rounding or truncating.

Note that this procedure does not require pairwise computation of distances between all pairs of pages; rather, assuming an appropriate data structure—such as a tree that supports traversal by quantized timestamp—the page (or pages) at a given time delta from another page (such as the current faulting page) can be found by traversing the data structure starting at the faulting page. Recall that with the limited delta sizes made possible by this invention, there will in most cases be no need to traverse the data structure far to find neighboring pages (in the appropriate ordered space, which is absolute time in this case).

### Delta Granularity

Current swap prefetchers predict deltas with a fixed degree of granularity, in particular, with page granularity. The invention makes it possible, however, to generalize deltas to support coarser granularities, or even a mix of different granularities, such that different levels of granularity can be used for delta values for different sub-sets of the entries in the data structure 422. As one option, the degree of granularity may increase with increasing distance of the page entries from that of the faulting page. Significantly, different granularities can be used with any types of deltas, including those representing distance in the virtual address space (as in the prior art), distance in the spatially ordered list of swapped-out pages, or distance in the temporally ordered list of swapped-out pages. Note that, if the variable-granularity method is applied to deltas determined as in the prior art, based solely on distance in the contiguous virtual address space, then it will not be necessary to create and maintain the data structure 422, since deltas can then be computed easily as the difference in addresses.

For example, if each delta represents a group of N pages, this will extend the range of deltas by a factor of N. As a simple example, assume that the pages nearest to P that have been swapped out are J, K, L, M, N, O, (P), Q, R, S, T, U, V . . . using any of the mentioned orderings. If, for example, N=2, for deltas that represent distances in the virtual address space, the system may divide each page number in the virtual address space by N and truncate the value, such that Q/2 and R/2 may both yield the same value (if they are close enough) and thus be processed as a group. As a result, a predicted delta would correspond to a group of swapped-out pages, and a system may prefetch all of them, or some subset. One way to select the common delta values for the different groups is such that they increase with increasing difference between the virtual addresses of the contiguous regions relative to the virtual address of the faulting page. Each common delta value may, for example, be a logarithmic function of the size of the respective contiguous region. Note that by setting N equal to a power of 2, this division and truncation may be accomplished quickly, simply by right-shifting the respective page numbers by log 2N bits. Similarly, division or shift operations may be used to increase (coarsen) granularity in temporal spaces as well, that is, for deltas based on counts or absolute time differences.

An appropriate value of N to optimize this tradeoff may be determined by modeling or analysis and will in many cases depend on the type of processes being run and the type(s) and sizes of memory being managed, but the inventors anticipate based on their experience that small values such as N=4 will be reasonable. An additional advantage of coarser delta granularity is that it enables the use of larger I/O requests, which can often be processed more efficiently than multiple smaller I/O requests by storage devices. Although the value of N will in general be a design choice, using very large values of N (such as 1024 or even greater) may not be efficient for prefetching.

To improve efficiency even further, especially in the case of large N, the system could filter potential swap-outs and prevent the system from swapping out additional pages that are within a predicted region and therefore more likely to be accessed in the near future. In other words, when the prediction module 430 makes the prediction that a region of N pages is likely to be accessed in the near future (regardless of how this prediction was generated, or the particular value of N), in addition to (or instead of) prefetching those pages, the prediction module 430 may communicate the identifiers of the corresponding pages to the prefetch module 210, which may then suppress near-term swap-outs within this region. The threshold of what is “near-term” may be fixed, for example, according to a predetermined number of memory accesses, or variable, such as depending on the size of N. Such filtering may be applied for any value of N, even N=1, but will in most cases be more advantageous for large values of N, for example, where it may be relatively expensive to prefetch the entire region, but inexpensive to prevent further swap-outs from this region. Note that this method does not require the granularity N to be fixed.

In yet another embodiment of the invention, variable-granularity deltas are supported. For example, the system might use exact page granularity (N=1) for deltas within a distance of ±16 pages, pairs of pages (N=2) for distances between 16 and 32, and coarser groups (N>2) for larger distances, effectively forming a hierarchy of granularities. As with fixed multi-page granularity, using coarser deltas implies prefetching more pages, which may negatively impact performance; however, using them as additional features may prove useful to provide more signal to train ML-based models, or to inform heuristic techniques.

### Leveraging Multiple Delta Types

Multiple different types of deltas can be combined for improved predictions by the prediction module 430. Different deltas could, for example, be applied for prediction for different contexts, but even for a single context. One option is to employ an ensemble of multiple different prediction models, each with a respective type of delta used on more than one ordered space. More than one ordered data structure 420 could therefore be implemented for a single context, for example, a process, using different ordering schemes. These data structures could be implemented as separately defined arrays, etc., or simply as logical partitions of a single such structure, with different types of deltas used for the different arrays/partitions. The sets of predictions generated by each model can be combined, using operations such as set union (to expand the overall set of predictions) or set intersection (to focus on predictions common to multiple models), weighted voting (such as Borda scores), or other known methods.

Alternatively, a single unified model could leverage multiple different ordered spaces directly, enabling an ML-based model to learn patterns within and across several ordered spaces. As one example, both spatial deltas in the virtual address space and temporal deltas, such as swap-out counts or times, in the space of swapped-out pages could be provided as inputs to the model. As another example, deltas for several different spaces could be precomputed and supplied as inputs to the model.

### Multi-Context Management

As used in this disclosure, a “context” is an identifier for a virtual address space, process, task, or thread. Multiple threads within a process share the same virtual address space, but different processes will have different virtual address spaces. In some cases, memory access patterns even within the same virtual address space will differ across threads, so a context may also include a process identifier (pid) and/or thread identifier (tid). The context identifier may be located in processor registers, memory used by the task, or in control registers used by some operating systems to directly manage the task.

The description above refers to a spatially or temporally ordered data structure that is used to determine which pages are preferably prefetched. This is by way of example, and to describe the use of those data structures. It would, however, be possible to create and maintain respective, different such data structures not only for a single context, but also for different processes or, more generally, different contexts or address spaces. In most cases, it will be preferable to segregate the sets of swapped-out pages by virtual address space, but this may in some cases not be optimal; for example, for temporal deltas, access patterns may exist across different contexts. In instances in which there are multiple, per-context data structures, there is, moreover, no requirement that these be of the same type (spatial, that is, in swap-out space, or temporal). Note that this multi-context arrangement is different from systems that operate with the type of spatial locality shown as type Il in Table 1, in which the physical swap space may happen to contain pages from multiple processes, but in which there is no per-context or per-process ordered data structure to support prefetching decisions.

### Implementation Considerations

In implementations that use an ML-based prefetcher, this prefetching component will learn access patterns to predict particular delta values that represent pages which are likely to be accessed in the near future, based on both the faulting page P and recent fault history. The training of an ML-based model compares the predicted set of page misses with the observed set of actual page misses, and updates model weights for improved prediction accuracy, so that, with high likelihood, the updated model will more correctly predict what actually happened. For example, in models based on neural networks, such modifications to the prediction model are typically performed using gradient descent via the backpropagation technique. The form of the predicted set affects the training, because the size and bound constraints on the predictions affect the feedback.

The “loss function” in such implementations may need to be modified, depending on what is perceived to be the relative cost of an error. For example, if the model predicts an ordering of the predicted pages in time, getting the right pages in the wrong temporal order should be considered more of a loss than getting the right pages in the right temporal order. The loss function could even be made to depend on a model of the latency of retrieving a swapped-out page, if the model's output is used to recommend an ordering of page reads from slow media.

1. A method for memory management in a computing system that has at least one processor, a memory management unit, near memory and swap memory, comprising:
maintaining at least one ordered data structure comprising entries identifying swapped-out memory pages;
identifying a current faulting page associated with an access to data stored in the swap memory;
ordering the entries in each ordered data structure according to a predetermined swap-out characteristic;
computing delta values for the entries in the ordered data structure, each delta value corresponding to a difference between the swap-out characteristic of each of the respective entries relative to the swap-out characteristic of the current faulting page;
predicting candidate pages corresponding to memory pages likely to be accessed by the processor as a function of the delta values; and
prefetching pages from the swap memory to the near memory corresponding to at least one of the candidate pages.

2. The method of claim 1, in which the predetermined swap-out characteristic is a virtual address of each swapped out page and further comprising computing the delta value for each entry in the ordered data structure as the difference between a positional index of the respective entry in the data structure relative to a positional index of the entry corresponding to the faulting page.

3. The method of claim 1, further comprising ordering the entries in the ordered data structure temporally in an order in which the respective swapped out pages were swapped out and computing the delta value for each entry in the ordered data structure as the difference between a positional index of the respective entry in the data structure relative to a positional index of the entry corresponding to the faulting page.

4. The method of claim 3, comprising ordering the entries in the ordered data structure temporally by
associating each swapped-out page with a respective value of a counter; and
incrementing the counter each time a new page is swapped out and a corresponding new entry is created in the ordered data structure;
the counter values thereby forming the positional index.

5. The method of claim 1, in which the predetermined swap-out characteristic is a swap-out time and further comprising computing the delta value for each entry in the ordered data structure as the difference between the swap-out time of each respective entry in the data structure relative to a swap-out time of the entry corresponding to the faulting page.

6. The method of claim 1, further comprising computing the delta values with different degrees of granularity for different sub-sets of the entries in the ordered data structure.

7. The method of claim 6, comprising increasing the degree of granularity with increasing distance between the swap-out characteristic of each of the respective entries relative to the swap-out characteristic of the current faulting page.

8. The method of claim 1, further comprising preventing subsequent swapping out of those pages whose entries in the ordered data structure fall within a region corresponding to entries likely to be accessed within a near-term period.

9. The method of claim 1, further comprising computing each delta value with a granularity of N pages corresponding to a plurality N of the entries in the ordered data structure, whereby the candidate pages are identified in groups.

10. The method of claim 9, further comprising increasing the granularity of N pages in each group as a function of a magnitude of the difference between the swap-out characteristic of each group relative to the swap-out characteristic of the faulting page.

11. The method of claim 1, further comprising maintaining a plurality of the ordered data structures simultaneously for each of a respective plurality of different processing contexts, in which the entries of each ordered data structure correspond to identified, swapped-out memory pages of the respective different processing contexts.

12. The method of claim 11, further comprising, for each of the plurality of the ordered data structures, independently selecting an ordering as one of: a temporal ordering and an ordering according to virtual addresses of the swapped-out memory pages.

13. The method of claim 1, further comprising:
maintaining a plurality of the ordered data structures simultaneously for the swapped out pages;
applying different ordering schemes to the said plurality of ordered data structures;
computing a plurality of different delta values of different types of deltas for entries in the ordered data structures, in which each delta type is chosen to be one of: a temporal ordering and an ordering according to virtual addresses of the swapped-out memory pages.

14. A system for memory management in a computing system that has at least one processor, a memory management unit, near memory and swap memory, comprising:
least one ordered data structure comprising entries identifying swapped-out memory pages, said entries being ordered according to a predetermined swap-out characteristic
a delta computation module configured to compute delta values for the entries in the ordered data structure, each delta value corresponding to a difference between the swap-out characteristic of each of the respective entries relative to the swap-out characteristic of a current faulting page, said current faulting page being associated with an access to data stored in the swap memory;
a prediction module configured to predict candidate pages corresponding to memory pages likely to be accessed by the processor as a function of the delta values; and
a prefetcher configured to prefetch pages from the swap memory to the near memory corresponding to at least one of the candidate pages.

15. The system of claim 14, in which:
the predetermined swap-out characteristic is a virtual address of each swapped out page, and
the delta computation module is further configured to compute the delta value for each entry in the ordered data structure as the difference between a positional index of the respective entry in the data structure relative to a positional index of the entry corresponding to the faulting page.

16. The system of claim 14, in which:
the ordered data structure is ordered temporally in an order in which the respective swapped out pages were swapped out; and
the delta computation module is further configured to compute the delta value for each entry in the ordered data structure as the difference between a positional index of the respective entry in the data structure relative to a positional index of the entry corresponding to the faulting page.

17. The system of claim 16, in which the delta computation module is further configured to
order the entries in the ordered data structure temporally by
associating each swapped-out page with a respective value of a counter; and
incrementing the counter each time a new page is swapped out and a corresponding new entry is created in the ordered data structure;
the counter values thereby forming the positional index.

18. The system of claim 14, in which:
the predetermined swap-out characteristic is a swap-out time; and
the delta computation module is further configured to compute the delta value for each entry in the ordered data structure as the difference between the swap-out time of each respective entry in the data structure relative to a swap-out time of the entry corresponding to the faulting page.

19. The system of claim 14, in which the delta computation module is further configured to compute the delta values with different degrees of granularity for different sub-sets of the entries in the ordered data structure.

20. The system of claim 19, in which the delta computation module is further configured to increase the degree of granularity with increasing distance between the swap-out characteristic of each of the respective entries relative to the swap-out characteristic of the current faulting page.

21. The system of claim 14, in which the prediction module is configured to communicate to the prefetcher identifiers of those pages whose entries in the ordered data structure fall within a region corresponding to entries likely to be accessed within a near-term period.

22. The system of claim 14, in which the delta computation module is further configured to compute each delta value with a granularity of N pages corresponding to a plurality N of the entries in the ordered data structure, whereby the candidate pages are identified in groups.

23. The system of claim 22, in which the delta computation module is further configured to increase the granularity of N pages in each group as a function of a magnitude of the difference between the swap-out characteristic of each group relative to the swap-out characteristic of the faulting page.

24. The system of claim 14, in which there is a plurality of the ordered data structures at the same time for each of a respective plurality of different processing contexts, in which the entries of each ordered data structure correspond to identified, swapped-out memory pages of the respective different processing contexts.

25. The system of claim 24, in which, for each of the plurality of the ordered data structures, the delta computation module independently selects an ordering as one of: a temporal ordering and an ordering according to virtual addresses of the swapped-out memory pages.

26. The system of claim 14, further comprising:
a plurality of the ordered data structures for the swapped out pages, each being arranged according to a different ordering scheme for the said plurality of ordered data structures;
in which the delta computation module is further configured to compute a plurality of different delta values for entries in the ordered data structures, in which each delta type is chosen to be one of: a temporal ordering and an ordering according to virtual addresses of the swapped-out memory pages.

27. A method for memory management in a computing system that has at least one processor, a memory management unit, near memory and swap memory, said swap memory backing portions of the virtual address space addressable by the memory management unit in a virtual address space, comprising:
predicting a plurality of delta values for a corresponding plurality of memory pages in the swap memory, each delta value representing a difference between a virtual address of each respective one of the memory pages relative to a virtual address of a faulting page, in which the delta values correspond to different spans of virtual addresses of the memory pages;
designating as candidates for prefetching the memory pages whose delta values fall within a range; and
prefetching pages from the swap memory to the near memory corresponding to at least one of the candidate pages.

28. The method as in claim 27, further comprising:
determining at least two subsets of the memory pages, in which the memory pages in each subset are located in respective contiguous regions of the virtual memory space and in which at least one of the subsets comprises more than one of the memory pages;
computing a common delta value for each of the subsets as a function of the delta values of the swapped out memory pages in each respective subset; and
prefetching all the pages in at least one of the subsets as a function of the common delta values.

29. The method as in claim 28, further comprising selecting the common delta values to be increasing with increasing difference between the virtual addresses of the contiguous regions relative to a virtual address of the faulting page.

30. The method of claim 29, in which each common delta value is a logarithmic function of the size of the respective contiguous region.

31. The method of claim 30, in which the logarithmic function is the logarithm to the base two.

32. The method of claim 29, further comprising preventing subsequent swapping out of those pages of the memory pages whose delta values are in a range indicating a likelihood that the corresponding memory pages are likely to be accessed within a near-term period.
